(19) United States
(12) Patent Application Publication
(10) Pub. No.: US 2016/0204647 A1
(43) Pub. Date: Jul. 14, 2016

(54) STORAGE BATTERY SYSTEM

(71) Applicant: TOSHIBA MITSUBISHI-ELECTRIC INDUSTRIAL SYSTEMS CORPORATION, Chuo-ku, Tokyo (JP)

(72) Inventors: Daisuke TSURUMARU, Tokyo (JP); Masato HANADA, Tokyo (JP)

(73) Assignee: TOSHIBA MITSUBISHI-ELECTRIC INDUSTRIAL SYSTEMS CORPORATION, Chuo-ku, Tokyo (JP)

(21) Appl. No.: 14/916,135

(22) PCT Filed: Sep. 19, 2013
(86) PCT No.: PCT/JP2013/075344

§ 371 Date: Mar. 2, 2016

(51) Int. Cl. H02J 7/02; H02J 7/04; H02J 7/00

(52) U.S. Cl. CPC H02J 7/027; H02J 7/0068; H02J 7/04

(57) ABSTRACT

A storage battery system having enhanced safety of the interlock processing. A storage battery system connected to a power system and operative based on a charge/discharge request from an EMS includes: a battery management unit configured to monitor a state of the storage battery; a power conditioning system; and a control device configured to receive the charge/discharge request and storage battery information supplied from the battery management unit and to control the power conditioning system based on the charge/discharge request and the storage battery information. The control device further includes an interlock processing unit configured to perform interlock processing upon detection of abnormality of the storage battery system, the interlock processing corresponding to a content of the detected abnormality.

### TECHNICAL FIELD

The present invention relates to a storage battery system connected to a power system.

### BACKGROUND ART

A power system is constructed by connecting a power generation facility and a load facility through a power transmission facility. There are power systems of various scales, ranging from large-scale systems that connect a plurality of large-scale power plants with a large number of plants, commercial establishments and households to small-scale systems constructed in specific facilities. The power systems of all the scales include an energy management system (EMS) that manages electric power supply/demand in the entire power system. The EMS balances electric power supply from the power generation facilities and electric power demand from the load facilities.

A storage battery system is connected to the power system as described above to be used as one means for balancing electric power supply/demand. Although a large amount of electric power was once thought hard to store, mass storage batteries like lithium ion batteries and sodium sulfur batteries, which are now in practical use, make it possible to store a large amount of electric power. By connecting the storage battery system including such storage batteries to the electric power system, it becomes possible to adopt such an operation as to charge the storage batteries with electric power excessively generated when electric power supply exceeds electric power demand and to discharge electric power from the storage batteries to compensate shortage of electric power caused when electric power demand exceeds electric power supply.

One adequate application example of such a storage battery system is a combination of the storage battery system with a power generation facility using energy of nature, such as sunlight and wind force. The power generation facilities using the energy of nature are widely being introduced in response to increased interest in energy issues or environmental issues of these days. However, the power generation facilities using the energy of nature have a disadvantage that natural factors, such as seasons and weather, tend to affect electric power to be generated and hinder stable supply of electric power. The storage battery system can make up for the disadvantage, so that stable electric power supply can be achieved by combining the storage battery system with the power generation facilities using the energy of nature.

When the storage battery system is connected to the power system, the operation of the storage battery system is managed by the above-mentioned EMS. The storage battery system includes a power conditioning system (PCS) connected to the storage battery. The PCS has a function of converting AC power of the power system into DC power and charging the storage battery with the DC power, and a function of converting DC power of the storage battery into AC power and discharging the AC power to the power system. When a charge/discharge request is supplied from the EMS to the PCS, the PCS operates in response to the charge/discharge request. As a result, charge of the storage battery with electric power from the power system or discharge of electric power from the storage battery to the power system is achieved.

The applicant of the present invention recognizes the following literature as related art of the present invention. FIG. 9 in Patent Literature 1 illustrates one example of a storage battery system connected to the power system.

### CITATION LIST

### Patent Literature

Patent Literature 1: Japanese Patent Laid-Open No. 2013-27210

Patent Literature 2: Japanese Patent Laid-Open No. 2012-75243

### SUMMARY OF INVENTION

### Technical Problem

The storage battery has a battery management unit (which is hereinafter also referred to as a BMU) attached thereto, the battery management unit being configured to monitor the state of the storage battery. The BMU monitors items including a current value, a voltage value, and a temperature, which are measured by sensors included in the BMU. The BMU detects abnormality of the storage battery from such parameters as the current value, the voltage value, and the temperature. The conventionally proposed storage battery system protects the storage battery by performing interlock processing based on major failure signals from the BMU indicative of overcharge, overdischarge, abnormal temperature, and the like. However, when the major failure signals are output from the BMU, the storage battery is in a considerably overloaded state. For example, a lithium ion battery is a storage battery using an inflammable organic solvent as an electrolyte to have high voltage and large current passing therethrough, so that safer interlock processing is desired.

The present invention has been made in view of the above-mentioned problem, and it is therefore an object of the present invention to provide a storage battery system having enhanced safety of the interlock processing.

### Solution to Problem

In order to accomplish the above object, a storage battery system according to the present invention is configured as described below.

The storage battery system according to the present invention is connected to a power system and is configured to operate based on a charge/discharge request from an energy management system that manages electric power supply/demand of the power system. There is no limitation on the scale and configuration of the power system to be connected to the storage battery system according to the present invention.

The storage battery system according to the present invention includes a storage battery, a battery management unit, a power conditioning system, and a control device. The storage battery may be constituted of a single storage battery cell, or may be constituted as an assembly of a plurality of storage battery cells. As for the type of storage battery, a mass storage battery such as a lithium ion battery, a sodium sulfur battery, and a nickel-hydrogen battery is preferable.

The battery management unit is configured to monitor the state of the storage battery on a constant basis or at a specified cycle. The battery management unit monitors the state quantity of monitoring items such as current, voltage, and temperature. As for the voltage, when the storage battery is constituted of a plurality of cells, the voltage of each cell is preferably monitored. The battery management unit measures the state quantity of the monitoring items with sensors on a constant basis or at a specified cycle, and outputs some or all of the obtained data to the outside as storage battery information.

The battery management unit includes an interlock function to turn off a contactor connecting the power conditioning system and the storage battery when a major fault such as overcharge, overdischarge, and abnormal temperature of the storage battery is detected from a current value, a voltage value, a temperature, and the like. Specifically, the battery management unit has a BMU upper limit threshold and a BMU lower limit threshold set for each of the state quantities of such parameters as current, voltage, and temperature. For example, the battery management unit determines occurrence of overcharge when the voltage value of the storage battery is higher than the BMU upper limit threshold, whereas the battery management unit determines occurrence of overdischarge when the voltage value is lower than the BMU lower limit threshold. The current value and the temperature may also be determined in a similar manner. When the battery management unit determines occurrence of any major fault, the battery management unit performs interlock processing to forcibly turn off the contactor connecting the power conditioning system and the storage battery.

The power conditioning system is configured to connect the storage battery to the power system. The power conditioning system has a function of converting AC power of the power system into DC power and charging the storage battery with the DC power and a function of converting DC power of the storage battery into AC power and discharging the AC power to the power system. The power conditioning system is also called a power conditioner, which regulates the amount of electric power for charging the storage battery and the amount of electric power discharged from the storage battery. The power conditioning system refers to output values of sensors in adjustment of the charge electric power amount and the discharge electric power amount. The sensors include, for example, a current sensor and a voltage sensor for measuring physical values relating to the charge electric power amount and the discharge electric power amount.

The control device is a device interposed between the energy management system and the power conditioning system. The control device receives the charge/discharge request supplied from the energy management system to the storage battery system. The control device is configured to receive, together with the charge/discharge request, the storage battery information supplied from the battery management unit and to control the power conditioning system based on the charge/discharge request and the storage battery information.

The control device includes an interlock processing unit. The interlock processing unit is configured to perform interlock processing upon detection of abnormality of the storage battery system, the interlock processing corresponding to a content of the detected abnormality. The interlock processing unit is configured to detect abnormality of the storage battery system based on at least one of the storage battery information supplied from the battery management unit and the power conditioning system information supplied from the power conditioning system. It is to be noted that the abnormality of the storage battery system detected in the interlock processing unit signifies a fault less serious than the major faults detected in the battery management unit.

The interlock processing unit is preferably configured to include processing of stopping output of a charge/discharge command to the power conditioning system as the interlock processing. Once the output of the charge/discharge command is stopped, indication values of the charge electric power amount and the discharge electric power amount become zero, and the power conditioning system stops charge/discharge operation. The interlock processing unit is preferably configured to include processing of outputting a trip command to the power conditioning system as the interlock processing. In addition, the interlock processing unit is preferably configured to include processing of turning off the contactor connecting the power conditioning system and the storage battery as the interlock processing.

Specifically, the interlock processing unit has an FBCS upper limit threshold and an FBCS lower limit threshold set for each of the state quantities of such parameters as current, voltage, and temperature. The FBCS upper limit threshold is set lower than the BMU upper limit threshold. The FBCS lower limit threshold is set lower than the BMU lower limit threshold. For example, when the voltage value included in the storage battery information or the power conditioning system information is higher than the FBCS upper limit threshold, the interlock processing unit determines occurrence of overcharge. When the voltage value is lower than the FBCS lower limit threshold, the interlock processing unit determines occurrence of overdischarge. The current value and the temperature may also be determined in the similar manner. When the interlock processing unit determines occurrence of any abnormality, the interlock processing unit performs at least one interlock processing out of stopping output of the charge/discharge command, outputting the trip command, and turning off the contactor described before, depending on the content of the abnormality. The content of the abnormality is preset based on the type of detection parameters, the number of abnormal detection parameters, the amount of deviation between a detection value and a threshold, and the like.

### Advantageous Effects of Invention

According to the storage battery system in the present invention, it becomes possible to provide a storage battery system having enhanced safety of the interlock processing.

### BRIEF DESCRIPTION OF DRAWINGS

FIG. 1 is a conceptual block diagram for describing the system configuration according to a first embodiment of the present invention.

FIG. 2 is a block diagram of the system according to the first embodiment of the present invention.

FIG. 3 is a flow chart of a control routine executed by the storage battery system 10 to implement the interlock function in the first embodiment of the present invention.

FIG. 4 is a flow chart of a control routine executed by the storage battery system 10 to implement the interlock function in the second embodiment of the present invention.

FIG. 5 is a flow chart of the control routine executed by the storage battery system 10 to implement the interlock function in the third embodiment of the present invention.

### DESCRIPTION OF EMBODIMENT

Hereinafter, an embodiment of the present invention will be described in detail with reference to the drawings. It is to be noted that like component members are designated by like reference signs to omit redundant description.

### First Embodiment

### Overall Configuration of First Embodiment

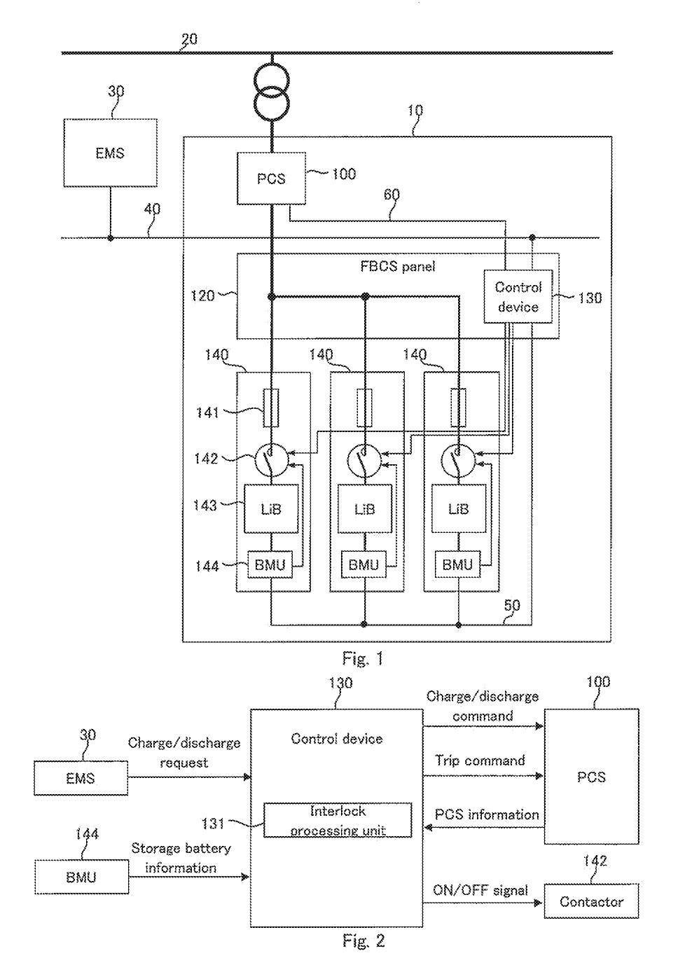

FIG. 1 is a conceptual block diagram for describing the system configuration according to a first embodiment of the present invention. A storage battery system 10 illustrated in FIG. 1 is connected to a power transmission facility 20 of a power system. The power system includes, in addition to the power transmission facility 20, a power generation facility (illustration omitted) connected to the power transmission facility 20, and a load facility (illustration omitted) connected to the power transmission facility 20. The storage battery system 10 is connected to an energy management system (hereinafter referred to as EMS) 30 present in the distant through a computer network 40. The EMS 30 manages electric power supply/demand of the power system, such as the power generation amount of the power generation facility, the charge/discharge amount of the storage battery system 10, and the power reception amount of the load facility.

The storage battery system 10 includes a power conditioning system (hereinafter referred to as PCS) 100, a front battery control station panel (hereinafter referred to as FBCS panel) 120, and storage battery panels 140. In the storage battery system 10, one PCS 100 is connected to one FBCS panel 120, and the one FBCS panel 120 is connected a plurality of storage battery panels 140 in parallel. Although three rows of storage battery panels 140 are provided in FIG. 1, this configuration is merely an example. The number of the storage battery panels 140 arranged in parallel is determined based on the specification of the PCS 100. Therefore, only one storage battery panel 140 may be provided in parallel. Although the storage battery system 10 has one PCS 100 in FIG. 1, this configuration is also merely an example. The number of the PCSs 100 arranged in parallel is determined based on the specification of the storage battery system 10. Therefore, the number of the PCSs 100 in parallel may be two or more.

### (Storage Battery Panel)

The storage battery panel 140 includes a fuse 141, a contactor 142, a storage battery module 143, and a battery management unit (hereinafter referred to as BMU 144). The storage battery module 143 is a module constituted of a plurality of cells connected in series. Each cell is a lithium ion battery (LiB). The storage battery module 143 is connected to the FBCS panel 120 via the contactor 142 and the fuse 141 and through a power transmission line. The storage battery module 143 is also connected to the BMU 144 through a signal line. The BMU 144 is connected to the control device 130 on the FBCS panel 120 through a computer network 50, and to the contactor 142 through the signal line.

The BMU 144 monitors the state of the storage battery module 143. Specifically, the BMU 144 includes a current sensor (illustration omitted), a voltage sensor (illustration omitted), and a temperature sensor (illustration omitted) as means for measuring the state quantities of the storage battery module 143. The current sensor measures current passing through the storage battery module 143. The voltage sensor is provided for each cell to measure the voltage of each cell. The temperature sensor measures the temperature of the storage battery module 143. These sensors do not necessarily have to be provided inside the casing of the BMU 144. These sensors attached to the storage battery module 143 and the BMU 144 may be connected through the signal line. The storage battery module 143 is constantly monitored by the BMU 144. However, the constant monitoring described in the present embodiment is a concept including not only the operation of taking in continuous signals without an intermission from the sensors but also the operation of taking in the signals of the sensors at a specified short cycle. The BMU 144 transmits to the control device 130 storage battery information including the information obtained by measurement performed by each sensor.

The contactor 142 is disposed between the fuse 141 and the storage battery module 143. Upon reception of an ON signal, a point of contact of the contactor 142 is set to ON and so the contactor 142 is turned on. Upon reception of an OFF signal, the point of contact is set to OFF and so the contactor 142 is turned off. For example, the ON signal is a current of more than a specified value [A], and the OFF signal is a current of less than the specified value [A]. When the contactor 142 is turned on, the PCS 100 and the storage battery module 143 are electrically connected, and when the contactor 142 is turned off, the PCS 100 and the storage battery module 143 are electrically disconnected.

### (FBCS Panel)

The FBCS panel 120 is connected to the storage battery panels 140 and the PCS 100. Specifically, the storage battery panels 140 are each connected to the FBCS panel 120 through individual power transmission lines. The individual power transmission lines converge inside the FBCS panel and are connected to a thicker power transmission line. The converged power transmission line is connected to the PCS 100. The FBCS panel 120 also includes the control device 130. The control device 130 includes memories including a ROM and a RAM for example, an input/output interface for inputting and outputting a variety of information, and a processor that can execute various arithmetic processes based on the variety of information. The control device 130 is connected to the EMS 30 through the computer network 40, to the BMU 144 through the computer network 50, and to the PCS 100 through a computer network 60. The control device 130 is connected to the contactor 142 through the signal line.

The control device 130 plays the role of a commander that issues a charge/discharge command to the PCS 100. In one example, the control device 130 receives a charge/discharge request transmitted from the EMS 30 and storage battery information transmitted from the BMU 144. The charge/discharge request includes a request with respect to active power and reactive power charged and discharged by the PCS 100. The charge/discharge request includes a specific request numerically indicating a specific electric power amount, and an abstract request requesting maximum charge/discharge power. The control device 130 determines a charge/discharge command (equivalent to a charge/discharge amount [kW]) to be issued to the PCS 100 based on the charge/discharge request and the storage battery information, and transmits the command to the PCS 100. The control device 130 also includes functions such as a function of safely controlling the performance and life of the storage battery module 143 to the maximum, a function of outputting a trip signal to the PCS 100, and a function of turning on and off the contactor 142.

### (PCS)

The PCS 100 is connected to the power transmission facility 20 via a transformer and through the power transmission line. The PCS 100 has a charging function of converting AC power of the power system into DC power and charging the storage battery module 143 with the DC power, and a discharging function of converting DC power of the storage battery module 143 into AC power and discharging the AC power to the power system. The amount of electric power to charge the storage battery module 143 and the amount of electric power discharged from the storage battery module 143 are adjusted by the PCS 100. Regulation of the charge/discharge electric power amount by the PCS 100 is performed in accordance with the charge/discharge command supplied from the control device 130.

The PCS 100 includes a current sensor (illustration omitted) and a voltage sensor (illustration omitted). The current sensor measures the current that charges the storage battery module 143 or that is discharged from the storage battery module 143. The voltage sensor measures the voltage of the storage battery module 143 subjected to charge or discharge. The PCS 100 adjusts the charge/discharge electric power amount with reference to the output values of these sensors. The PCS 100 transmits to the control device 130 output values of these sensors as power conditioning system information.

### Characteristic Configuration of First Embodiment

FIG. 2 is a block diagram of the system according to the first embodiment of the present invention. In FIG. 2, a block representing the control device 130 contains blocks representing some of various functions included in the control device 130. An arithmetic resource is assigned to each of these blocks. Programs corresponding to the respective blocks are prepared for the control device 130, and these programs are executed by the processor, so that the functions of the respective blocks are implemented in the control device 130.

The control device 130 receives a charge/discharge request from the EMS 30, and receives storage battery information from the BMU 144. The control device 130 determines a charge/discharge command based on the charge/discharge request and the storage battery information, and transmits the charge/discharge command to the PCS 100.

### (Interlock Function)

The control device 130 has an interlock function, which is implemented by the interlock processing unit 131. Management of voltage, current, and temperature is important for safe operation of the storage battery. The storage battery system 10 has a hardware interlock mechanism in which the BMU 144 forcibly turns off the contactor 142 when the BMU 144 detects major failures, such as overdischarge, overcharge, and abnormal temperature. Specifically, the BMU 144 has a BMU upper limit threshold and a BMU lower limit threshold set for each of the state quantities of such parameters as current, voltage, and temperature. For example, when the voltage values of the cells are higher than the BMU upper limit threshold, the BMU 144 determines occurrence of overcharge. When the voltage values are lower than the BMU lower limit threshold, the BMU 144 determines occurrence of overdischarge. The current value and the temperature may also be determined in the similar manner. When the BMU 144 determines occurrence of any major fault, the BMU 144 performs interlock processing of forcibly turning off the contactor connecting the PCS 100 and the storage battery module 143.

However, when the major failures are detected in the BMU 144, the storage battery module 143 is already in a considerably overloaded state.

Accordingly, in the system of the present embodiment, the interlock processing unit 131 of the control device 130 detects abnormality of the storage battery system 10 and executes software interlock control, before the BMU 144 detects the major failures and executes hardware interlock control. It is to be noted that the abnormality of the storage battery system 10 detected in the interlock processing unit signifies a fault less serious than the major faults detected in the BMU 144.

Specifically, the interlock processing unit 131 first stops output of a charge/discharge command to the PCS 100, and outputs a trip command to the PCS 100. In addition, the interlock processing unit 131 outputs an OFF signal to turn off the contactor 142. Once the output of the charge/discharge command is stopped, indication values of the charge electric power amount and the discharge electric power amount become zero, and the PCS 100 stops charge/discharge operation. Upon reception of the trip command, the PCS 100 shuts off its own circuit. Upon reception of the OFF signal (to turn off the ON signal), the contactor 142 is forcibly turned off.

More specifically, the interlock processing unit 131 has an FBCS upper limit threshold and an FBCS lower limit threshold set for each of the state quantities of such parameters as current, voltage, and temperature. The FBCS upper limit threshold is set lower than the BMU upper limit threshold. The FBCS lower limit threshold is set lower than the BMU lower limit threshold. For example, when the voltage value included in the storage battery information or the power conditioning system information is higher than the FBCS upper limit threshold, the interlock processing unit 131 determines occurrence of overcharge. When the voltage value is lower than the FBCS lower limit threshold, the interlock processing unit 131 determines occurrence of overdischarge. The current value and the temperature may also be determined in the similar manner. When the interlock processing unit 131 determines occurrence of any abnormality, the interlock processing unit 131 performs at least one interlock processing out of stopping output of the charge/discharge command, outputting the trip command, and turning off the contactor described before, depending on the content of abnormality. The content of the abnormality is preset based on the type of detection parameters, the number of abnormal detection parameters, the amount of deviation between a detection value and a threshold, and the like.

As described in the foregoing, the FBCS upper limit threshold is set lower than the BMU upper limit threshold, and the FBCS lower limit threshold is set lower than the BMU lower limit threshold. Accordingly, the interlock processing unit 131 can execute software interlock control before the BMU 144 performs hardware interlock operation. This makes it possible to prevent occurrence of the major failures of the storage battery module 143.

Moreover, since the interlock processing unit 131 performs multiplex interlock processing including stopping output of the charge/discharge command to the PCS 100, outputting the trip command output to the PCS 100, and turning off the contactor, occurrence of serious abnormality can more reliably be prevented.

When the control device 130 (interlock processing unit 131) is failed, the contactor 142 is forcibly turned off by the hardware interlock operation performed by the BMU 144. Accordingly, safety of the storage battery system 10 is doubly ensured by software interlock operation by the control device 130 and hardware interlock operation by the BMU 144.

### (Flow Chart)

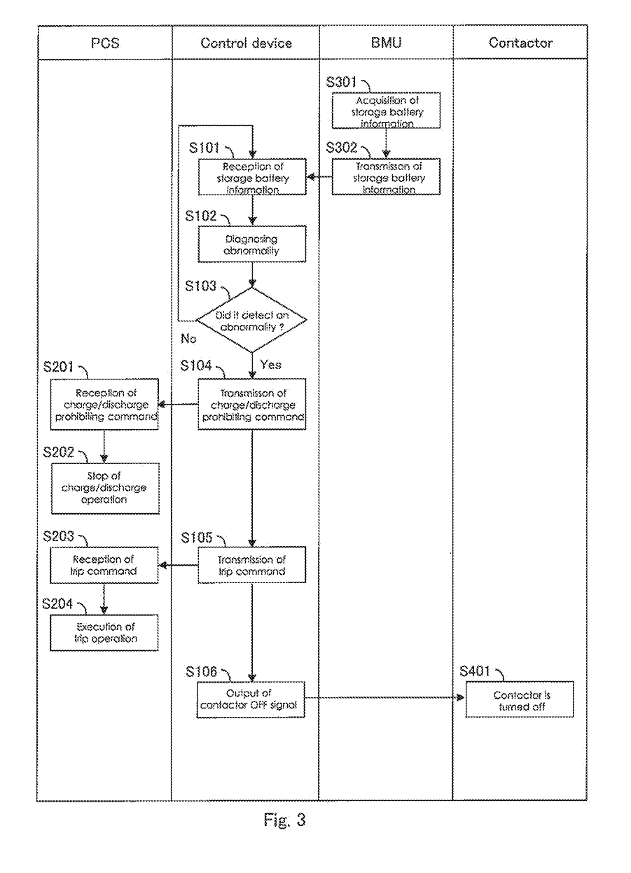

FIG. 3 is a flow chart of a control routine executed by the storage battery system 10 to implement the interlock function in the first embodiment of the present invention. FIG. 3 illustrates software interlock processing based on the storage battery information supplied from the BMU 144. Processing of the control device 130 illustrated in this flow chart is implemented by the function of the interlock processing unit 131. The memory of the control device 130 stores programs for executing the processing of the flow chart illustrated in FIG. 3. When the processor of the control device 130 reads and executes the programs, the processing illustrated in FIG. 3 is implemented.

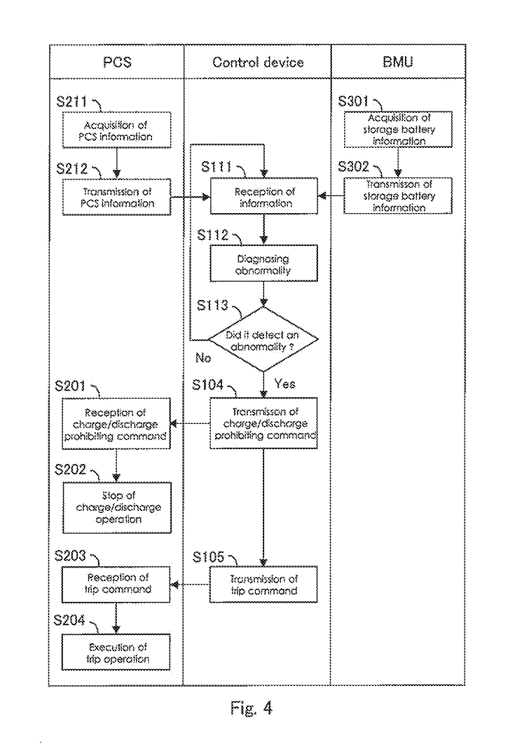

In the routine illustrated in FIG. 4, the BMU 144 first acquires storage battery information on the constant basis by using the various sensors described before (step S301). The storage battery information includes the current passing through the storage battery module 143, the voltage of each cell, and the temperature of the storage battery module 143. Then, the BMU 144 transmits the acquired storage battery information to the control device 130 (step S302).

The control device 130 receives the storage battery information transmitted from the BMU 144 (step S101). It is to be noted that each of the following processes in the control device 130 is executed whenever the storage battery information is received.

As described in the foregoing, the control device 130 (interlock processing unit 131) stores the FBCS upper limit threshold and the FBCS lower limit threshold with respect to each of the state quantities of such parameters as current, voltage, and temperature included in the storage battery information. The control device 130 compares each of the state quantities with the FBCS lower limit threshold and the FBCS upper limit threshold (step S102).

The control device 130 detects abnormality of the storage battery system 10, when any one of the state quantities is larger than the FBCS upper limit threshold, or when any one of the state quantities is smaller than the FBCS lower limit threshold (step S103). When abnormality is detected, the processing proceeds to step S104. When no abnormality is detected, the processing returns to step S101, and acquisition of next storage battery information is waited.

When abnormality is detected, the control device 130 transmits to the PCS 100 a command to prohibit charge/discharge (step S104). The PCS 100 receives the command to prohibit charge/discharge transmitted from the control device 130 (step S201). The PCS 100 stops charge/discharge operation (step S202).

The control device 130 transmits a trip command to the PCS 100 after processing of step S104 (step S105). The PCS 100 receives the trip command transmitted from the control device 130 (step S203). The PCS 100 shuts off its own circuit (step S204).

The control device 130 outputs an OFF signal to turn off the contactor 142 after processing of step S105 (step S106). Upon reception of the OFF signal, the point of contact of the contactor 142 is set to OFF so that the contactor 142 is turned off (step S401).

In the flow chart illustrated in FIG. 3, all the processes including stopping output of the charge/discharge command, outputting the trip command, and turning off the contactor opening are performed as the interlock processing when abnormality is detected. However, the present invention is not limited thereto. At least one interlock process may be performed.

Although the control device 130 is placed on the FBCS panel 120 in the system of the first embodiment described in the foregoing, the placement position of the control device 130 is not limited thereto. For example, the control device 130 may be placed in the PCS 100, the storage battery panel 140, or in any one of the BMUs 144. Moreover, various functions mounted on the control device 130 may be mounted on the PCS 100, and be installed in the PCS 100. These various functions may also be installed in the storage battery panel 140 and on the BMUs 144. These points also apply in the following embodiments.

### Second Embodiment

### Overall Configuration of Second Embodiment

Now, a second embodiment of the present invention will be described with reference to FIG. 4. The system of the present embodiment may be implemented by causing the system to execute a later-described routine of FIG. 4 in the configuration illustrated in FIGS. 1 and 2.

### Characteristic Configuration of Second Embodiment

In the above-described first embodiment, the control device 130 (interlock processing unit 131) detects abnormality of the storage battery system 10 based on only the storage battery information supplied from the BMU 144, and performs the interlock processing. However, the method for detecting abnormality of the storage battery system 10 is not limited to the described method. In the second embodiment, the control device 130 (interlock processing unit 131) detects abnormality of the storage battery system 10 based on the storage battery information and the power conditioning system information supplied from the PCS 100.

### (Flow Chart)

FIG. 4 is a flow chart of a control routine executed by the storage battery system 10 to implement the interlock function in the second embodiment of the present invention. FIG. 4 illustrates software interlock processing based on the storage battery information supplied from the BMU 144 and the power conditioning system information supplied from the PCS 100. Processing of the control device 130 illustrated in this flow chart is implemented by the function of the interlock processing unit 131. The memory of the control device 130 stores programs for executing the processing of the flow chart illustrated in FIG. 4. When the processor of the control device 130 reads and executes the programs, the processing illustrated in FIG. 4 is implemented.

In the routine illustrated in FIG. 4, the PCS 100 first acquires power conditioning system information on the constant basis by using the various sensors described before (step S211). The power conditioning system information includes current passing through the storage battery module 143 and voltage of the storage battery module 143. Then, the PCS 100 transmits the acquired power conditioning system information to the control device 130 (step S212).

The BMU 144 acquires storage battery information on the constant basis by using the various sensors described before (step S301). The storage battery information includes current passing through the storage battery module 143, voltage of each cell, and temperature of the storage battery module 143. Then, the BMU 144 transmits the acquired storage battery information to the control device 130 (step S302).

The control device 130 receives the power conditioning system information transmitted from the PCS 100 and the storage battery information transmitted from the BMU 144 (step S111). It is to be noted that each of the following processes in the control device 130 is executed whenever the power conditioning system information and the storage battery information are received.

As described before, the control device 130 (interlock processing unit 131) stores the FBCS upper limit threshold and the FBCS lower limit threshold for each of the state quantities of the storage battery. The control device 130 compares each of the state quantities included in the power conditioning system information and the storage battery information with the FBCS upper limit threshold and the FBCS lower limit threshold (step S112). The control device 130 detects abnormality of the storage battery system 10 when any one of the state quantities is larger than the FBCS upper limit threshold, or when any one of the state quantities is smaller than the FBCS lower limit threshold (step S113).

It is to be noted that the method for diagnosing abnormality in the processing of steps S112 and S113 is not limited to the described method. The state quantity (for example, the voltage of the storage battery module 143) included in the power conditioning system information may be compared with the state quantity (the sum of the voltages of the cells constituting the storage battery module 143) included in the storage battery information, and when a difference therebetween is out of an allowable range, abnormality may be detected.

When abnormality is detected, the processing proceeds to step S104. When no abnormality is detected, the processing returns to step S101, and acquisition of next power conditioning system information and next storage battery information is waited.

When abnormality is detected, the control device 130 transmits to the PCS 100 a command to prohibit charge/discharge (step S104). The PCS 100 receives the command to prohibit charge/discharge transmitted from the control device 130 (step S201). The PCS 100 stops charge/discharge operation (step S202).

The control device 130 also transmits a trip command to the PCS 100 after processing of step S104 (step S105). The PCS 100 receives the trip command transmitted from the control device 130 (step S203). The PCS 100 shuts off its own circuit (step S204).

As described in the foregoing, the storage battery system 10 in the second embodiment can implement the interlock function described in the first embodiment, and therefore the effect same as the system of the first embodiment can be achieved.

In the flow chart illustrated in FIG. 4, the processes including stopping output of the charge/discharge command and outputting the trip command are performed as the interlock processing when abnormality is detected. However, the present invention is not limited thereto. Either one of the interlock processes may be performed. Turning off the contactor may also be performed as the interlock processing.

### Third Embodiment

### Overall Configuration of Third Embodiment

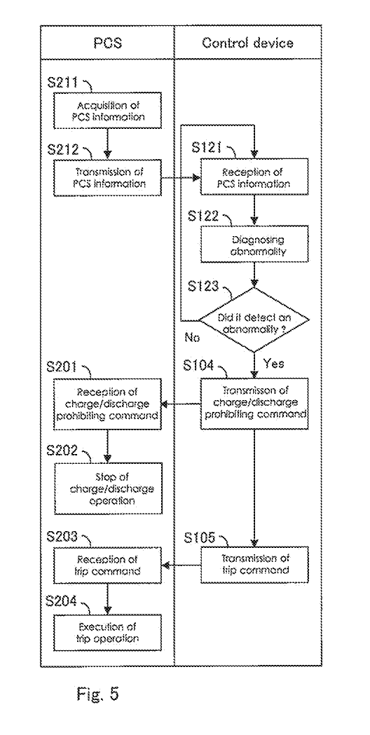

Now, a third embodiment of the present invention will be described with reference to FIG. 5. The system of the present embodiment may be implemented by causing the system to execute a later-described routine of FIG. 5 in the configuration illustrated in FIGS. 1 and 2.

### Characteristic Configuration of Third Embodiment

In the above-described first embodiment, the control device 130 (interlock processing unit 131) detects abnormality of the storage battery system 10 based on the storage battery information supplied from the BMU 144, and performs the interlock processing. However, the method for detecting abnormality of the storage battery system 10 is not limited to the described method. In the third embodiment, the control device 130 (interlock processing unit 131) detects abnormality of the storage battery system 10 based on the power conditioning system information supplied from the PCS 100.

### (Flow Chart)

FIG. 5 is a flow chart of the control routine executed by the storage battery system 10 to implement the interlock function in the third embodiment of the present invention. FIG. 5 illustrates software interlock processing based on the power conditioning system information supplied from the PCS 100. Processing of the control device 130 illustrated in this flow chart is implemented by the function of the interlock processing unit 131. The memory of the control device 130 stores programs for executing the processing of the flow chart illustrated in FIG. 5. When the processor of the control device 130 reads and executes the programs, the processing illustrated in FIG. 5 is implemented.

In the routine illustrated in FIG. 4, the PCS 100 first acquires power conditioning system information on the constant basis by using the various sensors described before (step S211). The power conditioning system information includes current passing through the storage battery module 143 and voltage of the storage battery module 143. Then, the PCS 100 transmits the acquired power conditioning system information to the control device 130 (step S212).

The control device 130 receives the power conditioning system information transmitted from the PCS 100 (step S121). It is to be noted that each of the following processes in the control device 130 is executed whenever the power conditioning system information is received.

As described before, the control device 130 (interlock processing unit 131) stores the FBCS upper limit threshold and the FBCS lower limit threshold for each of the state quantities of the storage battery. The control device 130 compares each of the state quantities included in the power conditioning system information with the FBCS upper limit threshold and the FBCS lower limit threshold (step S122). The control device 130 detects abnormality of the storage battery system 10 when any one of the state quantities is larger than the FBCS upper limit threshold, or when any one of the state quantities is smaller than the FBCS lower limit threshold (step S123).

When abnormality is detected, the processing proceeds to step S104. When no abnormality is detected, the processing returns to step S101, and acquisition of next storage battery information is waited.

When abnormality is detected, the control device 130 transmits to the PCS 100 a command to prohibit charge/discharge (step S104). The PCS 100 receives the command to prohibit charge/discharge transmitted from the control device 130 (step S201). The PCS 100 stops charge/discharge operation (step S202).

The control device 130 transmits a trip command to the PCS 100 after processing of step S104 (step S105). The PCS 100 receives the trip command transmitted from the control device 130 (step S203). The PCS 100 shuts off its own circuit (step S204).

As described in the foregoing, the storage battery system 10 in the third embodiment can implement the interlock function described in the first embodiment, and therefore the effect same as the system of the first embodiment can be achieved.

In the flow chart illustrated in FIG. 5, the processes including stopping output of the charge/discharge command and outputting the trip command are performed as the interlock processing when abnormality is detected. However, the present invention is not limited thereto. Either one of the interlock processes may be performed. Turning off the contactor may also be performed as the interlock processing.

### REFERENCE SIGNS LIST

10 Storage battery system
20 power transmission facility
30 Energy management system (EMS)
40, 50, 60 Computer network
100 Power conditioning system (PCS)
120 FBCS panel
130 Control device
131 Interlock processing unit
140 Storage battery panel
141 Fuse
142 Contactor
143 Storage battery module
144 Battery management unit (BMU)

1. A storage battery system connected to a power system and operative based on a charge/discharge request from an energy management system that manages electric power supply/demand of the power system, the storage battery system comprising:
a storage battery;
a battery management unit configured to monitor a state of the storage battery;
a power conditioning system having a function of converting AC power of the power system into DC power and charging the storage battery with the DC power and a function of converting DC power of the storage battery into AC power and discharging the AC power to the power system;
a control device configured to receive the charge/discharge request and storage battery information supplied from the battery management unit and to control the power conditioning system based on the charge/discharge request and the storage battery information, wherein
the control device further includes an interlock processing unit configured to perform interlock processing upon detection of abnormality of the storage battery system, the interlock processing corresponding to a content of the detected abnormality.

2. The storage battery system according to claim 1, wherein
the interlock processing unit is configured to detect abnormality of the storage battery system based on at least one of the storage battery information and power conditioning system information supplied from the power conditioning system.

3. The storage battery system according to claim 1, wherein
the interlock processing unit includes processing of stopping output of a charge/discharge command to the power conditioning system as the interlock processing.

4. The storage battery system according to claim 1, wherein
the interlock processing unit includes processing of outputting a trip command to the power conditioning system as the interlock processing.

5. The storage battery system according to claim 1, wherein
the power conditioning system and the storage battery are connected by a contactor, and
the interlock processing unit includes processing of turning off the contactor as the interlock processing.

6. The storage battery system according to claim 1, wherein
the battery management unit prestores a first upper limit threshold and a first lower limit threshold with respect to a state quantity of the storage battery, and turns off the contactor connecting the power conditioning system and the storage battery when the state quantity of the storage battery is larger than the first upper limit threshold or when the state quantity is smaller than the first lower limit threshold, and
the interlock processing unit prestores a second upper limit threshold lower than the first upper limit threshold and a second lower limit threshold higher than the first lower limit threshold, and detects abnormality of the storage battery system when the state quantity of the storage battery included in at least one of the storage battery information and the power conditioning system information supplied from the power conditioning system is larger than the second upper limit threshold, or when the state quantity is smaller than the second lower limit threshold.
